(19) United States
(12) Patent Application Publication
(10) Pub. No.: US 2005/0041983 A1
(43) Pub. Date: Feb. 24, 2005

(54) Method of forming a coded optical signal with a return to zero or non return to zero format

(75) Inventor: Hans Bissessur, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/890,120

(22) Filed: Jul. 14, 2004

(30) Foreign Application Priority Data
Aug. 19, 2003 (FR) 03 09 997

(51) Int. Cl. H04B 10/04

(52) U.S. Cl. 398/186

(57) ABSTRACT

The present invention relates to a method of forming a coded optical signal by intensity modulating a continuous carrier wave with binary data conforming to a non return to zero or a return to zero format, the coded signal having a main band of given bandwidth (B′), characterized in that, to reduce the bandwidth, it comprises phase modulation in the form of positive impulsive phase variations and negative impulsive phase variations adapted to be substantially synchronized with the rising edges and falling edges, respectively, of the modulated amplitude, or vice-versa.

The present invention relates to transmitting digital data by optical means. It relates in particular to transmitting high bit rates on optical fibers and more precisely to a method of forming a coded optical signal by intensity modulating a carrier light wave with binary data in accordance with a (non) return to zero format.

Increasing the capacity of optical transmission systems is being attempted in this art. In current dense wavelength division (DWDM) optical fiber transmission systems there is a requirement to increase the spectral efficiency (expressed by the ratio in bit/s/Hz of the modulation frequency to the frequency spacing between adjacent transmission channels) whilst preventing spectral overlapping between channels.

At present, a DWDM system uses modulation at a bit rate of 10 Gbit/s with a frequency spacing reduced to 25 GHz, yielding a spectral efficiency of 0.4 bit/s/Hz.

To become competitive, 40 Gbit/s systems must support a frequency spacing between channels of less than 100 GHz, for example a frequency spacing equal to 50 GHz to conform to the current standardization chart issued by the International Telecommunications Union (ITU).

Non return to zero (NRZ) or return to zero (RZ) modulation is very frequently used and entails varying the intensity of the carrier wave between two levels. The level variations are triggered at times imposed by a clock frequency and define successive time cells assigned to the binary data to be transmitted. By convention, the low level and the high level represent the binary values ‘0’ and ‘1’, respectively.

An NRZ pulse lasts for the maximum time assigned to each bit, i.e. a bit time T, but not an RZ pulse.

FIG. 1 represents the classic spectrum of an NRZ coded optical signal, to be more precise its optical power P (in dB) as a function of its frequency f (in arbitrary units).

This spectrum is characterized by a main band comprising a central maximum peak 1 associated with the carrier wave and two symmetrical side-bands 2, 3 relating to coding and on respective opposite sides of the peak 1.

This main band has a −10 dB bandwidth B approximately equal to 59 GHz at approximately 40 Gbit/s. So, a spacing of 50 GHz in a 40 GHz system would lead to excessive overlapping of the main bands of adjacent channels. This crosstalk would increase the transmission error rate unacceptably.

However, the two side-bands 2, 3 contain redundant information and filtering out one of them in order to increase the spectral efficiency is known in the art.

One such method used at a bit rate of 10 Gbit/s is described in the document “Vestigial side-band filtering at 10 Gb/s using 12.5 GHz channel spacing demux”, C. X. Yu et al., Electronics Letters, pp. 237-238, 2002, for example.

However, filtering is difficult because it entails precise and delicate adjustment of the position of the filter. Also the carrier wavelength, depending on the laser source, will vary over time and/or as a function of temperature, so that it is necessary to slave the filter to the spectrum.

Furthermore, for good operation, a specific shape filter characteristic is required that is complicated to obtain.

Another prior art solution for spectral compression of a coded signal is based on using the duobinary or phase-shaped binary transmission (PSBT) format described in the document “A 1580 nm band WDM transmission technology employing optical duobinary coding”, Journal of Lightwave Technology, pp. 191-199, 1999, for example.

In addition to NRZ intensity modulation, this format is characterized by phase modulation in the form of pulses with level changes centered in a ‘0’. For example, the height and the sign of the variations are selected as a function of the environment of a ‘0’, i.e. according to whether it is surrounded by ‘0’ binary values, to left or the right of a group of ‘1’ binary values or isolated between two ‘1’ binary values. The variation is generally of the order of ±π.

Duobinary coding employs a push-pull modulator controlled by an electrical coder coupled to an electrical low-pass filter, typically a Mach-Zehnder interferometer modulator, necessarily with its two arms controlled by opposite control voltages.

Generating that kind of duobinary coded signal is very complicated, especially as determining an operating point involves a large number of parameters (bias voltages, peak-to-peak voltage, etc.) and necessitates delicate control around the minimum non-null transmission point.

Furthermore, transmission performance is significantly worse than for an NRZ or an RZ coded signal, especially in terms of the signal-to-noise ratio and the sensitivity, i.e. the power necessary at the receiver to obtain a given error rate.

An object of the invention is to provide a reduced bandwidth coded optical signal that is simple to obtain and of good quality even at high bit rates, for example at 40 Gbit/s.

The invention finds a particular application to transmitting wavelength division multiplexed coded signals.

To this end the invention proposes a method of forming a coded optical signal by intensity modulating a continuous carrier wave with binary data conforming to a non return to zero or a return to zero format, the coded signal having a main band of given bandwidth, characterized in that, to reduce the bandwidth, it comprises phase modulation in the form of positive impulsive phase variations and negative impulsive phase variations adapted to be substantially synchronized with the rising edges and falling edges, respectively, of the modulated intensity, or vice-versa.

The method of the invention dispenses with band filtering.

Phase modulation in accordance with the invention is novel and simpler to implement than PSBT format modulation. In practice a phase modulator may be used that is separate from and either upstream or downstream of an intensity modulator.

Phase modulation in accordance with the invention does not prevent additional phase modulation of the ‘chirp’ type as employed in certain intensity modulation schemes, for example when modulating only one electrode of a “z-cut” LiNb03 Mach-Zehnder modulator.

In one advantageous embodiment, the impulsive phase variations have a maximum absolute value from 0.5 to 1.8 radians and preferably substantially equal to 0.75 radians.

This range of variation guarantees optimum signal quality in terms of bandwidth and thus optimum received signal quality when a plurality of wavelengths with a small frequency spacing are multiplexed.

Thus phase modulation of low amplitude is sufficient to obtain spectral compression. This improves power consumption by reducing the control voltage to be applied to the phase modulator and reduces the cost of the components.

To simplify the implementation, the positive and negative impulsive phase variations are preferably substantially symmetrical.

To optimize further the spectral compression, the mid-height width of the impulsive phase variations may be greater than or equal to half the transmission period (T/2).

The shape of the impulsive phase variations is preferably substantially triangular.

This substantially triangular shape is preferred over a pulse shape in which the transient level of the phase is maintained.

The absolute value of the time offset between the impulsive phase variations and the rising or falling edges is preferably less than or equal to approximately 12% of the transmission period.

In a preferred embodiment, with a plurality of coded signals being formed in accordance with said method as defined above, the method further comprises the selection of a frequency spacing for the carrier waves less than twice the bit rate.

This is made possible by the spectral compression obtained.

Moreover, the method may comprise filtering after coding and preferably by an AWG multiplexer or by a multiplexer with an interleaver.

This filtering improves transmission quality, in particular at the level of crosstalk between adjacent bands.

The invention also proposes a coding system for implementing the above-defined method and comprising, for each carrier wave to be modulated, phase modulation means and intensity modulation means that are preferably integrated onto the same support.

In a preferred embodiment, the phase modulation means comprise an electro-optical modulator based on lithium niobate and the intensity modulation means comprise a Mach-Zehnder interferometer modulator preferably based on lithium niobate.

Other features and advantages of the invention will become apparent on reading the following description of embodiments of the invention given by way of example and with reference to the accompanying drawings, in which:

FIG. 1, already described, shows the spectrum of a conventional optical signal that is only NRZ coded,

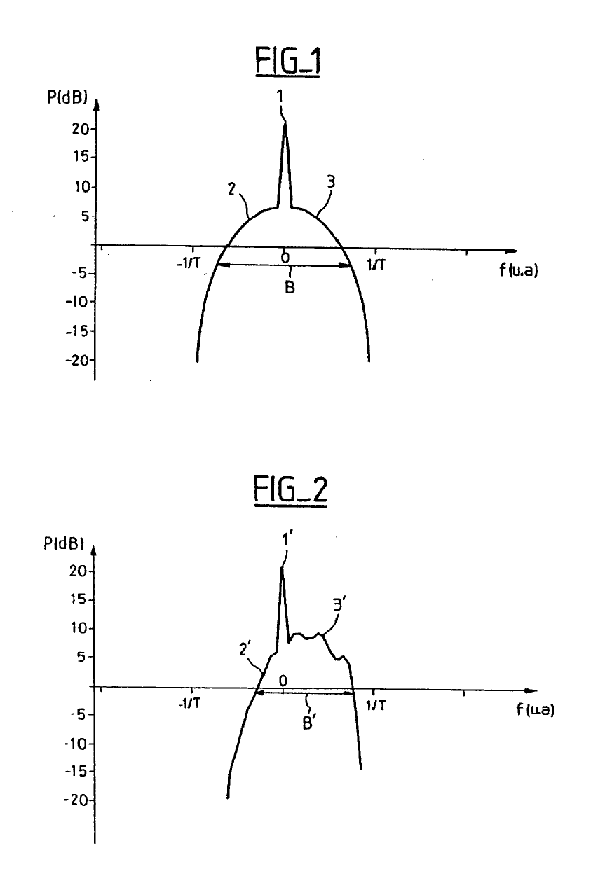

FIG. 2 shows the spectrum of an NRZ coded optical signal phase-modulated in accordance with a first preferred embodiment of the invention,

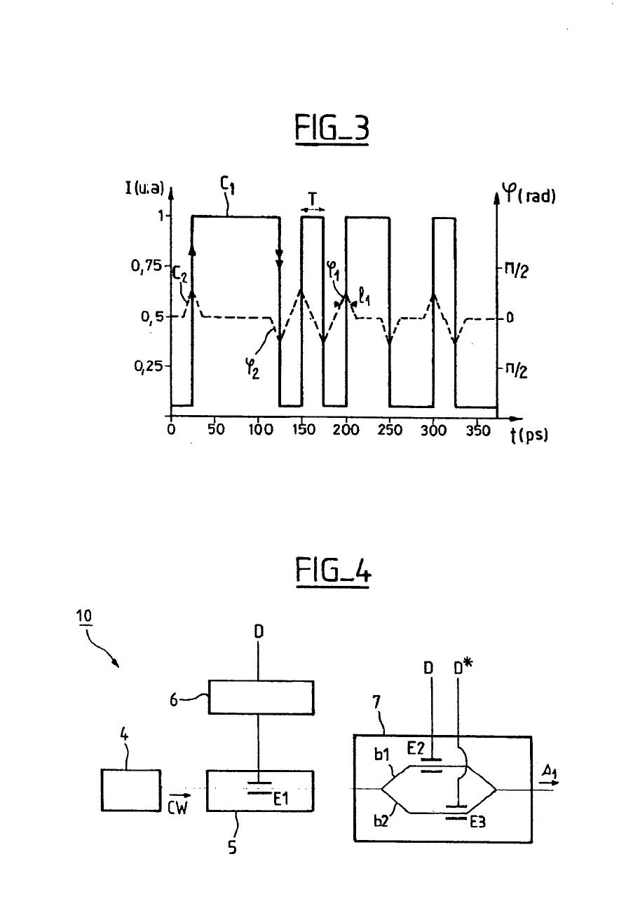

FIG. 3 shows the intensity and phase modulation necessary to obtain the FIG. 2 spectrum,

FIG. 4 shows one example of a generator of the NRZ coded and phase-modulated signals whose characteristics are shown in FIGS. 2 and 3,

FIG. 5 shows a system for transmitting three NRZ coded multiplexed signals phase-modulated in accordance with a second embodiment of the invention,

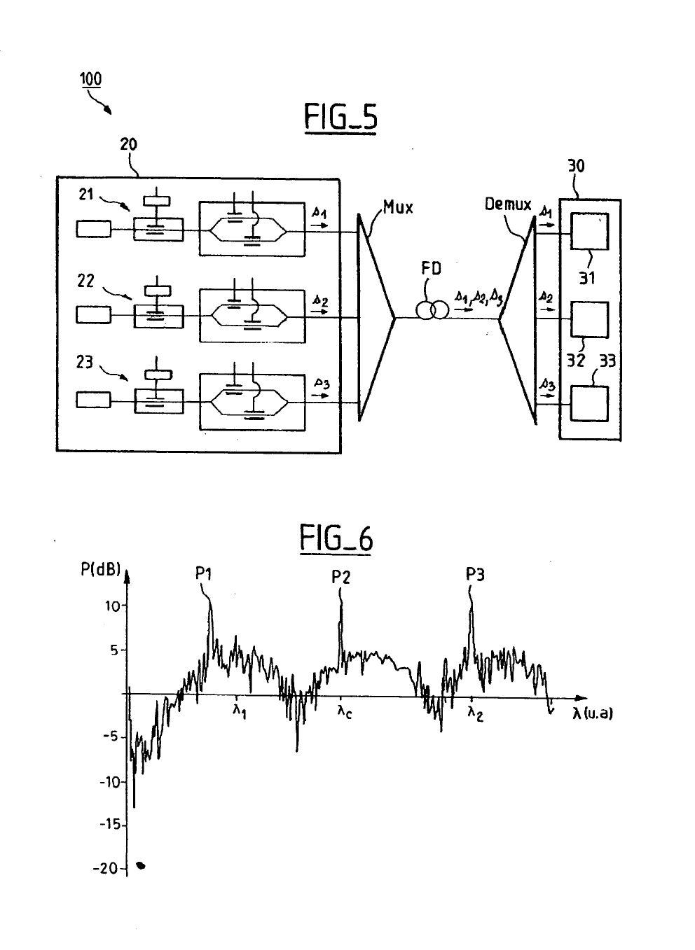

FIG. 6 shows the spectra of three multiplexed signals transmitted by the FIG. 5 transmission system, and

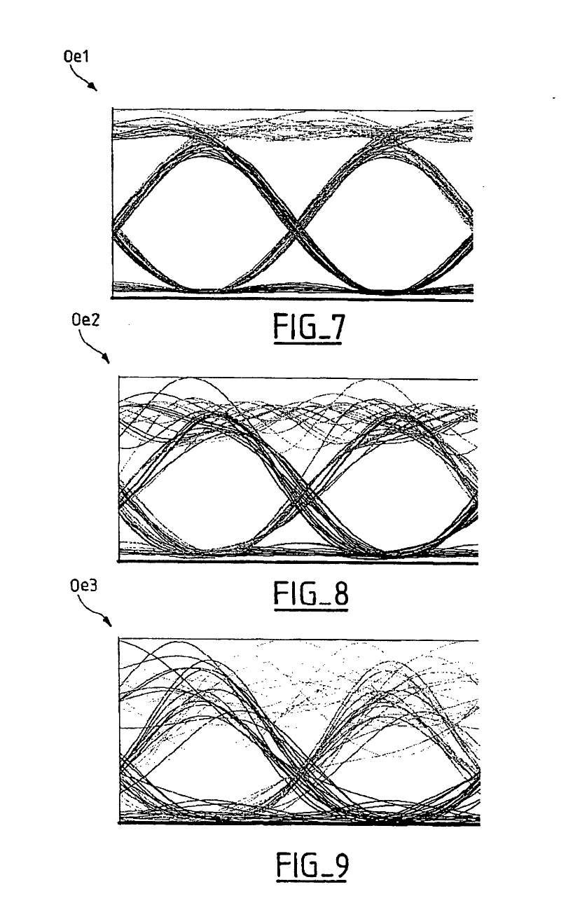

FIGS. 7 to 9 are three eye diagrams, the first two being associated with the FIG. 6 transmission system and the last one with an NRZ only transmission system.

FIG. 2 shows the spectrum of an NRZ coded optical signal phase-modulated in accordance with a preferred first embodiment of the invention. To be more precise, the diagram shows the optical power P (in dB) of the signal as a function of its frequency f (in arbitrary units).

This spectrum is characterized by a main band comprising a maximum peak 1′ associated with the carrier wave and two asymmetrical side-bands 2′, 3′ on respective opposite sides of the peak 1′.

This main band has a −10 dB bandwidth B′ less than the conventional bandwidth B and equal to approximately 43 GHz at 40 GHz.

To be more precise, the left-hand side-band 2′ is greatly attenuated and virtually all of the energy is concentrated in the right-hand side-band 3′.

A frequency spacing of 50 GHz between channels becomes feasible in a 40 GHz transmission system without compromising the NRZ or RZ signal quality.

The band compression results from superimposing specific phase modulation on the conventional intensity modulation, for example NRZ modulation.

FIG. 3 shows curves C₁ and C₂ respectively representing the intensity modulation I (in arbitrary units) and the phase modulation φ (in radians) as a function of time t (in picoseconds).

The intensity modulation I is of pulsed form with steep rising edges (symbolized by an arrowhead) and steep falling edges (symbolized by a double arrowhead). The intensity modulation I is defined as a function of the following binary data sequence: 011110101100100.

The bit time is 25 ps for the coding at 40 GHz selected for this example.

The phase modulation takes the form of positive impulsive phase variations φ₁ and negative impulsive phase variations φ₂ that are substantially synchronized with the rising edges and the falling edges, respectively, of the modulated intensity.

To simplify control, the positive and negative impulsive phase variations φ₁, φ₂ are made substantially symmetrical.

For optimum bandwidth reduction, the pulses φ₁, φ₂ are locked to the rising and falling edges. However, the absolute value of a time offset between the impulsive phase variations and the rising and falling edges is less than or equal to approximately 12% of the bit time T, i.e. a time offset of ±3 ps relative to the rising and falling edges at 40 Gbit/s.

With the same aim in view, the pulses φ₁, φ₂ preferably have a maximum value of 0.75 radians.

A Dirac pulse is insufficient, and a mid-height width I₁ of the impulsive phase variation φ₁, φ₂ equal to half of the bit time is preferably chosen, for example.

The shape of the impulsive phase variations φ₁, φ₂ is substantially triangular.

In a variant (not shown), the positive impulsive phase variations φ₁ and the negative impulsive phase variations φ₂ are substantially synchronized with the falling edges and the rising edges, respectively. In this configuration, energy is concentrated at the lower frequencies (left-hand side-band) rather than the higher frequencies (right-hand side-band).

FIG. 4 shows one example of a generator 10 of the NRZ coded phase-modulated optical signal whose characteristics are shown in the preceding FIGS. 2 and 3.

This generator 10 comprises, in succession:

a laser 4 for emitting a continuous carrier wave CW at a wavelength in the C or L band, for example,

a phase modulator 5 that is controlled by a 40 GHz electrical precoder 6 on the basis of the data sequence D referred to hereinabove, and

an intensity modulator 7.

If necessary, the power of the laser 4 may be increased or an optical amplifier may be added to compensate optical losses caused by adding the phase modulator.

The phase modulator 5 is an electro-optical modulator based on lithium niobate with a waveguide structure.

Applying a variable voltage to the electrode E1 of this modulator 5 induces refractive index variations that cause variations in the phase of the carrier wave CW passing through the modulator.

To obtain the required phase variations (having the required shape, width, etc.) the length of the modulator 5 is adjusted and its efficiency is taken into account.

Of course, a ‘1’ binary value between two ‘1’ binary values or a ‘0’ binary value between two ‘0’ binary values must not create any phase variation.

A semiconductor-based phase modulator may also be envisaged.

The phase-modulated carrier wave then propagates in the intensity modulator 7, which is preferably a lithium niobate Mach-Zehnder interferometer modulator.

The control means are conventional. The electrodes E2, E3 of the arms b1, b2 are controlled by the data sequence D and its complement D*, respectively.

An electro-absorption modulator (EAM) may also be envisaged.

The phase-modulated NRZ coded signal s₁ is obtained at the output of the intensity modulator 7.

In a first variant, only one of the electrodes E2, E3 is commanded by either D or D*; the coded signal s₁ is then “chirped”.

In a second variant, phase modulation is effected after intensity modulation.

FIG. 6 shows a transmission system 100 for transmitting three multiplexed signals s₁ to s₃ that are NRZ coded and phase-modulated in accordance with the invention.

The system 100 comprises:

a set 20 of three generators 21, 22, 23 similar to the generator 10 already described,

a wavelength division multiplexer Mux,

a fiber optic transmission line OF,

a wavelength division demultiplexer Demux, for example an AWG demultiplexer, and

a set 20 of three receivers 31, 32, 33.

This 40 Gbit/s DWDM transmission system 100 uses an assignment plan with an equidistant frequency spacing of 50 GHz.

FIG. 3 shows the spectrum of the three coded and multiplexed signals s₁ to s₃.

The spectrum is an expression of the optical power P (in dB) of the signals as a function of their wavelength λ (in arbitrary units).

This spectrum has three maximum peaks P1 to P3 at respective carrier wavelengths λ₁, λ_{c}, λ₂ substantially equal to 1545.72 nm, 1546.12 nm, 1546.52 nm, respectively.

FIGS. 7 to 9 are three eye diagrams, the first two being associated with the FIG. 6 transmission system and the last one with an NRZ only transmission system.

The first eye diagram Oe1 shown in FIG. 7 is that obtained for the central coded signal s₂ if the multiplexer Mux is a filter component, for example an AWG multiplexer, preferably of the same kind as that selected for demultiplexing.

Multiplexing with an interleaver may also be envisaged.

The second eye diagram Oe2 shown in FIG. 8 is that obtained for the central coded signal s₂ if the multiplexer Mux is a passive component such as a coupler.

The third eye diagram Oe3 shown in FIG. 9 is that obtained for a central coded signal having only NRZ coding with a passive component type multiplexer.

The first eye diagram Oe1 is wide open and reflects the quality of the received signal despite the phase modulation.

The second eye diagram Oe2 is open to an acceptable degree, but the third eye diagram Oe3 is not.

The present invention is not limited to the examples and embodiments described and shown and the invention lends itself to numerous variants that will be evident to the person skilled in the art.

The invention applies equally well to an RZ coded signal by providing, if necessary, means for synchronizing the phase modulation with the intensity modulation, especially if the pulses are particularly narrow.

The invention applies equally well to a number of multiplexed signals greater than three.

1. A method of forming a coded optical signal (s₁ to s₃) by intensity modulating a continuous carrier wave (CW) with binary data (D, D*) conforming to a non return to zero or a return to zero format, the coded signal (s₁) having a main band of given bandwidth (B′), characterized in that, to reduce the bandwidth, it comprises phase modulation in the form of positive impulsive phase variations (φ₁) and negative impulsive phase variations (φ₂) adapted to be substantially synchronized with the rising edges and falling edges, respectively, of the modulated intensity (I), or vice-versa.

2. A method according to claim 1 for forming a coded signal (s₁ to s₃), characterized in that the impulsive phase variations (φ₁, φ₂) have a maximum absolute value from 0.5 to 1.8 radians.

3. A method according to either claim 1 for forming a coded signal (s₁ to s₃), characterized in that the negative and positive impulsive phase variations (φ₁, φ₂) are substantially symmetrical.

4. A method according to either claim 1 for forming a coded signal (s₁ to s₃), characterized in that the mid-height width (I₁) of the impulsive phase variations (φ₁, φ₂) is greater than or equal to half the transmission period (T).

5. A method according to either claim 1 for forming a coded signal (s₁ to s₃), characterized in that the shape of the impulsive phase variations (φ₁, φ₂) is substantially triangular.

6. A method according to either claim 1 for forming a coded signal (s₁ to s₃), characterized in that there is a time offset between the impulsive phase variations (φ₁, φ₂) and the rising or falling edges that has an absolute value less than or equal to approximately 12% of the transmission period (T).

7. A method according to either claim 1 for forming a coded signal (s₁ to s₃), characterized in that, when a plurality of coded signals are formed in accordance with said method, it comprises the selection of a frequency spacing for the carrier waves less than twice the bit rate.

8. A method according to either claim 1 for forming a coded signal (s₁ to s₃), characterized in that, when a plurality of coded signals are formed in accordance with said method, it comprises filtering after coding by an AWG multiplexer or by a multiplexer with an interleaver.

9. A coding system (10, 20, 21 to 23) for implementing the method defined in either claim 1, the system comprising for each carrier wave (CW) to be modulated, phase modulation means (5) and intensity modulation means (7).

10. A coding system (10, 20, 21 to 23) according to claim 9, characterized in that the phase modulation means (5) comprise an electro-optical modulator based on lithium niobate and the intensity modulation means (7) comprise a Mach-Zehnder interferometer modulator.
